(19) United States
(12) Patent Application Publication
(10) Pub. No.: US 2008/0273680 A1
(43) Pub. Date: Nov. 6, 2008

(54) SYSTEM AND METHOD FOR NETWORK COMMUNICATION USING ALTERNATIVE IDENTIFIERS

(76) Inventors: Ido Eli Zohar, Moshav Mishmeret (IL); Shai David Zohar, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/744,456

(22) Filed: May 4, 2007

(51) Int. Cl. H04M 3/42

(52) U.S. Cl. 379/201.01

(57) ABSTRACT

A system for retrieving communication sequence of a destination such as, for example a phone number and executing a call from a user to the destination, said system comprises: a user's network device, a device-application that is installed within the network device, an operation center and a database. The operation center retrieves a destination's communication sequence from the database, according to an input domain name transmitted by the device-application to the operation center. The device-application enables transmission of the input domain name and executing a call from the user's network device to the said destination using the retrieved communication sequence.

### FIELD OF THE INVENTION

The present invention generally relates to the field of network communication. More specifically, the present invention relates to network communication using alternative identifiers.

### BACKGROUND OF THE INVENTION

People do not easily remember Numbers. A textual string chosen as an identifier such as a name of a business or a person is more likely to be remembered than a sequence of digits such as a phone number.

As of today, phone numbers, in general, are required to follow a pattern imposed by the communication operator. For example, the number +972-3-7528667 contains “972” that is a country code, “3” that is an area code and exactly 7 digits representing the identifier of the subscriber inside the dialing area marked as “3”. The communication operator usually does not identify sequences comprised of 6 or less, or 7 or more digits. Businesses or persons that try to identify themselves by numerical identifiers related to textual meanings are severely limited by the requirements of a “legal” number. For example, the number “1-800-3569377” may be easier to remember as “1-800-FLOWERS”. When using a reduced numeric keypads the digit “3”, for example, may represent several characters such as “3”, “D”, “E” and “F”, therefore, the sequence “3569377” may be translated to, for example, “FLOWERS”.

Some communication operators offer complimentary services of easy-to-remember numerical identifiers by attaching a unique character to the number. For example, the sequence “*2345” instead of “03-7528667”. Unfortunately, there is a limited number of easy to remember combinations.

Calling a destination without having the destination's phone number or internet address usually requires calling an operator directory service center or going through a phone directory, acquiring the desired phone number or numbers and then calling the destination through a network device such as a phone, a mobile phone, an internet application such as Skype and the like. This procedure may be time consuming and inconvenient, especially when waiting on line for the service center to become available to receive the call. To solve this issue today's operator service centers may connect you directly to phone number retrieved by the said operator, but the user is still required to call the service center prior to being connected to the destination, and may still be required to wait on line until reaching communication the service center and receiving service.

A patent number JP2000078267 by Kamisaka Tetsuji, discloses a system to connect communication devices using a ‘word code’ by a linguistic expression in place of a numeral line number, for dial connection in a communication service. According to Tetsuji a ‘work code’ corresponding to a line number is generated by using numerals, symbols and a linguistic expression as a connection code in a communication service and registered in an Network Service Provider (NSP). The word code consists of a ‘word code identification number’, a ‘various service identification number’, and an ‘identification code by linguistic expression’. When a sender uses a telephone set to send the ‘word code identification number’ and the ‘various service identification number’ to an exchange, the exchange discriminates the ‘word code’ and makes access to the NSP. When the sender transmits the ‘identification code by linguistic expression’ according to a guidance from the NSP, the NSP converts it into a corresponding line number and connects it to an object recipient through the exchange.

Although Tetsuji's patent contains textual identifiers, Tetsuji's invention does not comprise an independent database that is external to the NSP system. Therefore, according to Tetsuji, the identifiers may be limited to the customer of a specific service provider and may require substantial changes in the provider's system as well as a substantial assimilation process.

Furthermore, Tetsuji's solution does not allow a two-way communication between the caller and the service provider. Since once the caller has sent the details, he may be obliged to wait for the call to be initiated by the provider without a two-way verification process between the service provider and caller's handset.

Tetsuji's solution does not contain an application placed in advance in the caller's handset, which may allow for the selection of various communication means (for instance Voice over Internet Protocol (VoIP), international communication etc).

A patent number US2004170257 by Gross Karen and Gal van Thomas, discloses a platform that provides access to multiple telecommunication services via a single telephone number (for example, voicemail services, facsimile messaging services, paging services, and outbound calling services). Although this solution allows a subscriber to select routing options associated with one identifier, the whole process described by Thomas and Karen is only executed once a regular call has been initiated through a standard identifier. No application is installed at caller's end-device, and therefore the operator of such a service must receive the call, hold it within his system and complete the routing process.

A patent number WO03056796 by Hauglum Per Lasse discloses a system and a method for connecting telephone calls directly on the basis of a text query. According to Lasse, an operator centre establishes a database that contains customer profiles. Customers, who wish to receive telephone calls from users, register such customer profiles in the operator centre. Any customer profile will contain a telephone domain name and at least one destination telephone number. When a user sends a text message, he must indicate a telephone domain name and an operator centre code. The database is then searched for the domain name and a destination telephone number corresponding to the indicated domain name is used to establish a call to that destination, and then the user is connected to the destination directly.

Although Lasse's patent enables retrieval of phone numbers and establishing of a call to the retrieved number, Lasse's solution is limited to text-based messages, through which the operator can receive a query and only to a wireless networking. Moreover, according to Lasse, the communication between the customer and the user is performed only through the operator and not directly from the user's device to the customer's device. Lasse does not disclose a system or a method for using a multiplicity of operators to enable a low cost communication between a user and a customer that call from different countries or use network devices that are connected to different companies or different networks.

According to Lasse, the system is connected to the operator, therefore requires the operator to customize and change its current configurations and workflows. Moreover, the system requires the operator to perform hardware installations, handle quality-assurance issues, robustness and so on. As an outcome, the system may have scalability difficulties, since each operator may have to integrate Lasse's system separately, facing the above mentioned computability issues. The necessity to change the operator's workflow might yield the mentioned customizing difficulties, extending delay times and increasing the probability for communication failure.

### SUMMARY OF THE INVENTION

The present invention is a novel system and a method for retrieving a communication sequence such as, for example a phone number of a destination and supporting an initiation of a call from a user to a destination, where the retrieval of the phone number is carried out using a user's device-application that is installed in the user's network device, an operation center and a database.

For a clearer and easier understanding of the embodiments and uses of the present invention, the term communication sequence may be replaced with the more specific term “phone number” in specific cases where the destination can be contacted by dialing a phone number. This may not limit the scope of any communication identification that enables identifying communication destinations such as, for example URL addresses and the like.

The user may input a domain name, which may be the name of the destination, through the user's network device. The domain name may replace the need to insert a phone number by using text, or voice identifiers, which may be the domain name. The domain name may be transmitted to the operation center through any predefined transmission code such as tones (DTMF); short messages service (SMS), Unstructured Supplementary Service Data (USSD) messages and the like, automatically generated by the device application according to some embodiments of the invention. The domain name inputted by the user may be transmitted to the operation center through the device-application. The operation center enables retrieving of at least one phone number of the input domain name from the database and transmitting the retrieved phone number back to the user's network device through the device-application.

According to embodiments of the present invention, the device-application may initiate communication between the user and the destination by automatically executing a call from the user's network device, or by presenting the retrieved phone number to the user, enabling the user to press the dialing or “send” button to execute the call.

According to other embodiments of the present invention, the call from the user to the destination may be actuated by a multiplicity of operators. At least one of the operators may allow communication through a predefined network communication system and technique such as VoIP (Voice over Internet Protocol), wireless communication networking and the like.

According to some embodiments of the invention, the device application, the operation center or both, may enable spell checking and correcting of input domain names. The input domain name may be checked against domain names stored in the operation center and when the name fails to be found—a spell-correcting algorithm, installed in the application may output, and display a list of the closest domain names found in the database.

Since the present invention discloses a method by which the initiation of the call is carried out by an application that is installed within the user's network device, the application may execute communication, using systems and processes that are already available by the network device and the NSP of the device. Therefore initiating a call may not require special software or hardware applications installed at the operator, or alternatively changing the current calling methods and workflows. Therefore, the present invention allows scaling-up the service to support a multiplicity and a variety of operators without requiring hardware and software installations. Avoiding the requirements of hardware and / or software installations may facilitate in reducing compatibility problems at the interface between different service providers and decreasing the probability of communication failure.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for retrieving a phone number of a destination through a device application, according to some embodiments of the present invention.

FIG. 2 is a flow diagram that schematically illustrates a method for retrieving a phone number of a destination through a device application, according to some embodiments of the present invention.

FIG. 3 is a schematic illustration of a system for retrieving a phone number of a destination through a device application, according to an embodiment of the present invention.

FIG. 4 is a schematic illustration of a system for establishing communication between a destination's and a user's network devices using at least one mediating operator, according to some embodiments of the present invention.

FIG. 5 is a schematic illustration of a system for establishing communication between a destination's and a user's network devices using at least one mediating operator, according to other embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention is a novel system and method for supporting of network communication between a user and a destination using domain name identifiers, where the user and the destination use network devices such as telephones, mobile phones, laptops, desktop computers and the like.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to he understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although stale diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

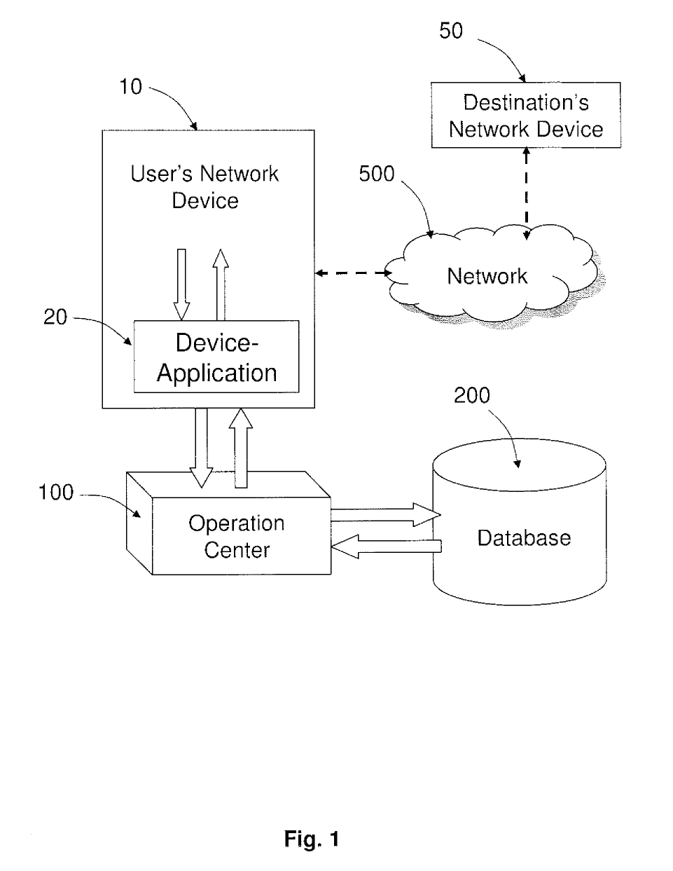

FIG. 1 schematically illustrates of a system for retrieving a phone number of a destination, according to some embodiments of the present invention. The system comprises a user's network device 10 that may include a device-application 20, an operation center 100 that enables communication with the user's network device 10 and retrieval of information from a database 200.

According to embodiments of the present invention, upon, receiving the retrieved phone number, device-application 20 may automatically initiate a call from the user's network device 10 to the destination's network device 50 through at least one communication network 500, such as wireless communication, line communication, internet communication and the like.

According to some embodiments of the present invention, as illustrated in FIG. 1, the user may input a domain name, which may be the name of the destination, through the user's network device 10. Device application 20 may facilitate communication with operation center 100. Upon receiving the input domain name from device application 20, operation center 100 may enable retrieving of at least one phone number of the input domain name from database 200 and transmitting the said retrieved phone number back to the user's network device 10 through the device-application 20. Device-application 20 may initiate communication between the user and the destination by automatically executing a call from the user's network device 10, or by presenting the retrieved phone number or numbers to the user and enabling the user to press the dialing or “send” button to execute the call.

According to embodiments of the present invention, device application 20 may be a software application that may be downloaded to user's network device 10 by the user, the network company, the manufacturer, or any other installer. For example, device application 20 may be available to users on the internet, where the users can download the software themselves, or installed by the phone company to the company's clients. Device-application 20 may be designed in several configurations, to fit various kinds of communication networks and communication with various kinds of operation centers 100.

According to embodiments of the present invention, the input domain names may be transmitted through Hyper Text Transfer Protocol (HTTP), Short Messaging Service (SMS) or Unstructured Supplementary Service Data (USSD) for example, as a text message, Dual-Tone MultiFrequency (DTMF) as tones-message, or through a voice message, where the user inputs the domain name by recording a user's voice message. Upon receiving the input domain name, operation center 100 may translate the input domain name into a text message, using any conversion device or software application that is known in the art for that purpose.

For example, a user wishes to contact a flower shop called “Flora”. The user may input the word “flora” as a legal domain name through device-application 20 that is installed in the user's network device 10, which is a mobile phone. The input domain name may then be transmitted to operation center 100 that may search database 200 to retrieve the phone number of “flora” shop. Once operation center 100 finds the domain's phone number, operation center 100 may transmit the phone number to the user's network device 10 through device-application 20. Device application 20 may then automatically execute a call to the retrieved phone number to “flora” shop's network device 50, which is a telephone. According to this example, the actual communication between the network devices 10 and 50 is carried out through the mobile network 500.

According to embodiments of the present invention, if the user inputs an illegal domain name or a domain name that is not found by operation center 200, the system may be preset to send device application 20 or user's network device 10 a notification message through an SMS, USSD, voice message or any other known messaging system. For example, an HTTP, USSD or SMS notification message of “Domain name not found”. Alternatively or additionally, the system may send a list of alternative legal domain names that exist in the database according to alphabetic order or according to a spell check that outputs a list of all database domain names that are close to the input domain name.

According to embodiments of the present invention, communication between user's network device 10 and operation center 100 may be carried out through sending of a code, where that code is designated to operation center 100. Operation center 100 may be able to identify the user's network device 10 by this code. The code may be transmitted according to user's network device's 10 applications. For example, if the input domain name is transmitted by a mobile phone through USSD—the code may be a target USSD number (to be recognized by a USSD gateway), SMS target number (to be recognized by the SMS Center), or the phone number of the operation center 100. As another example, if user's network device 10 is a mobile phone with access to the internet or a computer with internet access, the code may be a uniform resource locator (URL) used over HTTP or WAP protocols such as a website address, an email address and the like.

According to embodiments of the present invention, the code may be a signaling protocol such as Global Systems For Mobile communications (GSM) that uses RF (Radio Frequency) protocols, where the system may use the user's network device's 10 signaling to transmit the input domain name to operation center 100. According to this embodiment, operation device 100 may also identify the location of the user's network device 10. The information relating to user's network device's 10 location may be utilized for choosing which domain name operation center 100 may select. For example, if the user's network device 10 is located in Tel Aviv, and the user inputs the domain name of “flora”, which is a network of flower shops that has several branches across the country, operation center 100 may choose to retrieve the phone number of the branch that has a Tel Aviv area code.

According to some embodiments of the present invention, database 200 may comprise a list of domain names and their corresponding phone numbers, where the domain names are registered domain names of subscribers. Database 200 may enable users to register in database 200 through, for example, a website and a web-interface that are included in operation center 100. The said list may further include additional details that are associated with the specific domain name and its owner. For example, the address of the owner, other phone numbers to be reached in specific circumstances, the owner's available calling hours for each phone number, payment details of each phone number that are associated to the same domain name, files to be sent to device application 20, commercial or promotional information to be delivered to the caller, internal extension numbers associated with pre-defined rules, and the like.

According to other embodiments of the present invention, operation center 100 may download phone numbers or other information that are associated with an input domain name through web-based applications that search through external sources additionally or alternatively to database 200. For example, operation center 100 may connect to a directory website, search the website for the input domain name and extract the domain name's associated information from the website. Operation center 100 may be able to retrieve the phone number from the website by using applications that can read the content, of the website and identify phone numbers.

According to embodiments of the present invention, operation center 100 may include at least one web-server connected to a communication network. According to other embodiments of the present invention, operation center 100 may further include a website and a web-interface.

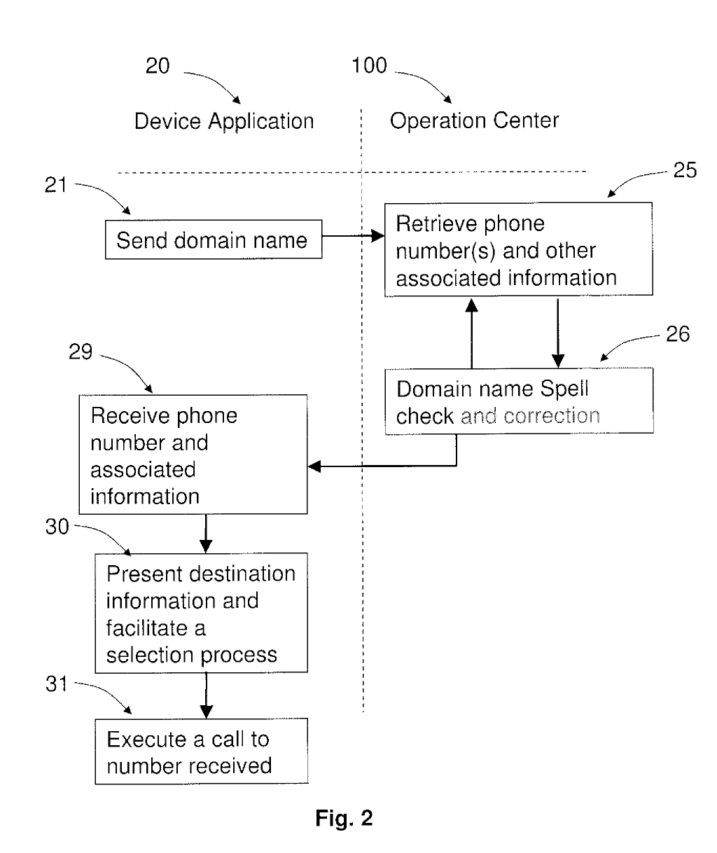

FIG. 2 schematically illustrates a method for retrieving a phone number of a destination and executing a call from a user to the destination, wherein said retrieval and execution are carried out using user's device-application 20 that is installed in user's network device 10. The method comprises the steps of:
sending an input domain name 21 to operation center 100, wherein the input domain name is generated by device-application 20;
retrieving the domain name's phone numbers and associated information 25, where operation center 100 retrieves the numbers and the information from database 200;
Spell check of the received domain name 26; an optional step in which the input domain name's spelling may be compared with domain names on database 200 and corrected if necessary;
receiving the retrieved phone number 29 through device-application 20 and the associated information:
presenting the destination's related information 30, where the related information such as, for example, the destination's phone number or list of phone numbers may be displayed on user's network device 10;
executing a call 31 to the destination network device 50 using at least one of the retrieved communication sequences (e.g. phone numbers, URL addresses and the like).

The device-application 20 initiates and executes the call to the destination through network 500 using the calling mechanism of user's network device 10.

According to some embodiments of the present invention, once the input domain name has been retrieved, device-application 20 may initiate a call to the destination, through the user's network device 10. The said initiation of the call may be carried out automatically or by the user's dialing. For example, upon receiving the retrieved phone number the system may automatically begin dialing the retrieved number. As another example, upon receiving the retrieved number, device-application 20 may present the said number on the user's network device 10's screen, where the user can press a dialing button, such as a “send” button to actuate the call. According to these embodiments, the call may be carried out regularly through the devices' communication network 500.

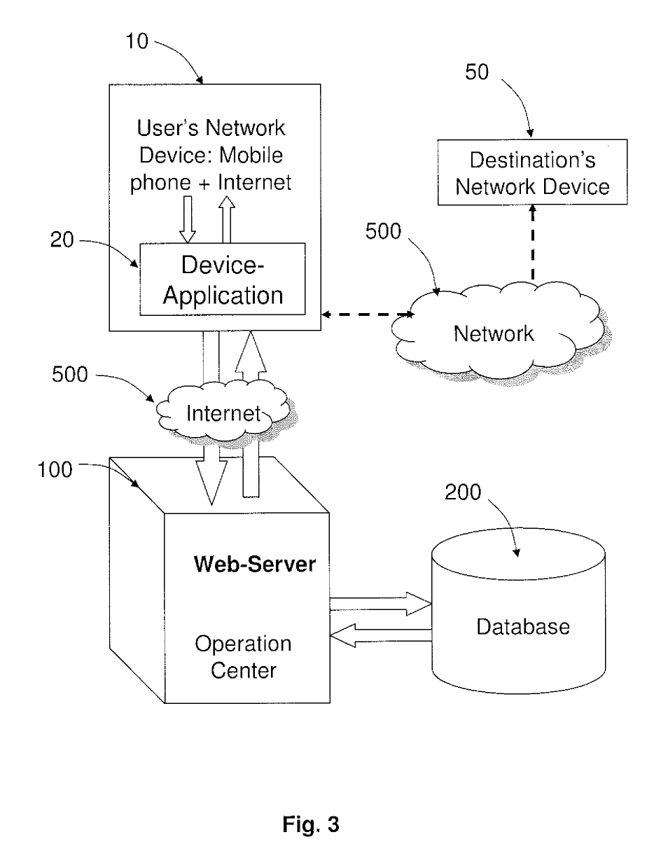

FIG. 3 schematically illustrates a system for retrieving a phone number of a destination, according to an embodiment of the present invention. Operation center 100, according to this embodiment, is accessed by a URL address sent by user's network device 10, where operation center 100 is a web-server and user's network device 10 has an internet access. According to this example, the input domain name may be inputted through an internet device-application 20 that utilizes internet protocols such as HTTP, WAP and the like.

According to embodiments of the present invention database 200 may comprise post-dial data associated with at least some of the registered domain names. For example, domain names of destination devices 50 that have extensions. In those cases device application 20 may be able to identify the extension number—associated with the phone number and post dial the extension once communication with the.

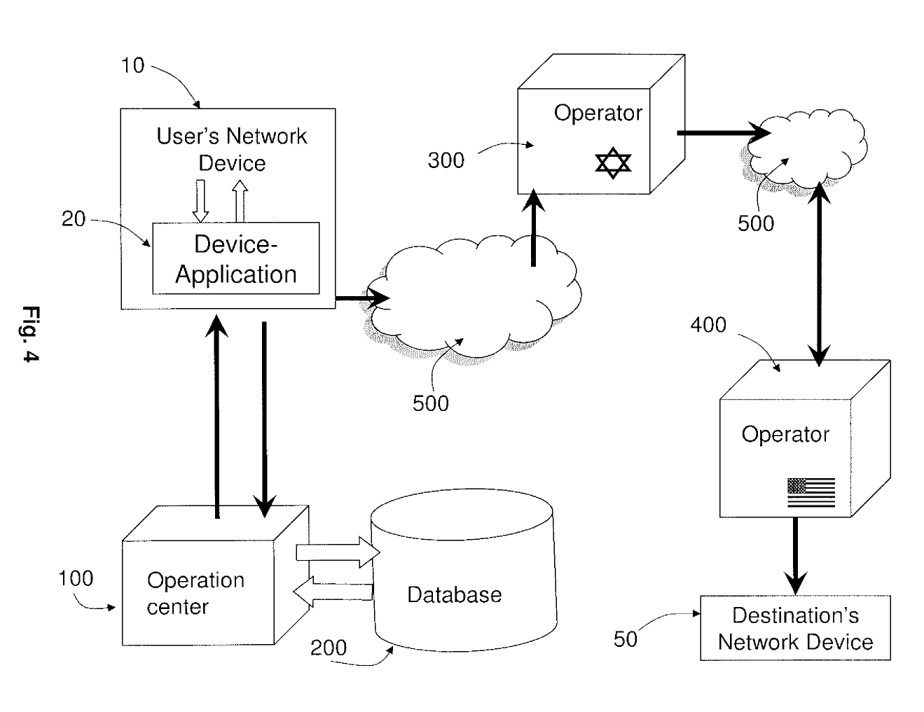

FIG. 4 schematically illustrates a system for establishing communication between user's and destination's network device 10 and 50, according to some embodiments of the present invention. User's network device 10 may be connected to a first mediating operator 300 through at least one network 500, where first mediating operator 300 may achieve communication with a second mediating operator 400 through another network 500. Second mediating operator 400 may execute and support the communication with destination's network device 50.

As an example to the embodiments that are illustrated in FIG. 4, user's and destination's network devices 10 and 50 are, for example, mobile phones. Device application 20 may transmit the input domain name to operation center 100, where operation center 100 may identify this domain name as an ‘abroad destination’ and output the communication sequence such as the phone number or the URL address of a first mediating operator 300 along with other related information. The related information may include, for example post dial digits (translated to DTMF tones) of the second operator 400 and the destination's phone number or domain name. In this case, device application 20 may receive the information from operation center 100, initiate a call to first mediating operator 300 and once the call is achieved—device application 20 may transmit the rest of the information through dialing the digits (post dial DTMF). Once first operator 300 receives the information it can contact second operator 400 through network 500 and second operator 400 may establish a call with destination's network device 50. This example may be useful to reduce the call cost between countries and/different providers of communication services, where the usually more costly communication between, for example, two operators located at different countries can be carried out through cheaper networks 500 such as VoIP over the internet and the like.

Communication between the user's network device 10 and first mediating operator 300 initiated by device application 20 and the communication between destination's network device 50 and the second mediating operator 400 may be carried out by various networks 500 known in the art and according to the devices' communication setup. For example, the communication between user's network device 10 and first operator 300 may be through using the mobile network 500 or the mobile internet options.

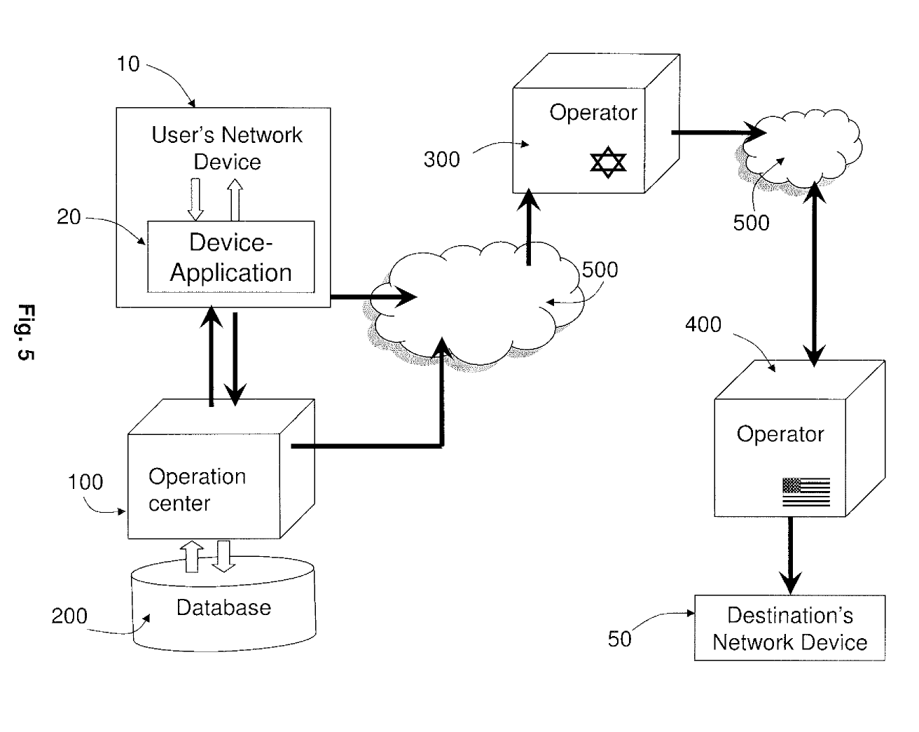

Alternatively, as illustrated in FIG. 5, according to other embodiments of the invention, the information following the phone number or URL address of the first mediating operator 300, retrieved by operation center 100, may be transmitted to first mediating operator 300 directly by operation center 100. Preferably, before device application 20 initiates the actual call to the destination, through the mediating operators 300 and 400 or any other additional operators—operation center 100 may already transmit the communication sequences to the first mediating operator 300. The communication sequences that may be transmitted by operation center 100 to first mediating operator 300 may be any data required to achieve communication with destination's network device 50. For example, the second operator's 400 URL address or any other addressing and the destination's domain name.

According to embodiments of the present invention, database 200 may include an attached priority list for at least part of the domain names. Each list may be attached to a domain name, where the list comprises a set of the domain name's owner requirements. For example, a domain name that is assigned to a subscriber that is registered in database 200. Through the process of registration the subscriber may insert several phone numbers of several destination's network devices 50 owned by him. Attached to the list of phone numbers, the subscriber may insert priority values that indicate the order in which operation center 100 should retrieve the domain name's phone numbers. For example, a subscriber has two network devices 50: a cellular phone and a telephone. The subscriber may select the cellular phone, for example, to be his first priority and the telephone to be his next priority. Correspondently, operation center 100 may first retrieve the cellular phone number and only if this number is unavailable for receiving a call—operation center may retrieve the telephone number. Additionally or alternatively, the subscriber may further attach other requirements such as numbers priority according to days of the week and hours of the day, etc.

According to some embodiments of the present invention, once a call is carried out using mediating operators 300 and 400, the system may automatically calculate that charge and charge the user (meaning the caller) according to the charging rate of the operators used for the purpose of executing of the call. For example, if the call from mediating operator 300 to second mediating operator 400 is carried out through VoIP, witch may be cheaper than from other communication systems the charging of the call from user's network device 10 to destination's network device 50 may be the summation of the charging rate from user's network device 10 to mediating operator 300, plus the charging rate from mediating operator 300 to second mediating operator 400, plus the charging rate from second mediating operator 400 to destination's network device 50. Additional charges (to the caller) may be included due to, for example, the communication services to operation center 100.

According to some embodiments of the present invention, device-application 20 may facilitate an advertising method. For example, operation center 100 may receive advertising messages from database 200 or any other source such as another main server. Since device-application 20 enables the receiving of messages, device-application 20 may be preprogrammed to provide management of the advertising messages (defined hereinafter as “ads”). Additionally or alternatively, operation center 100 as a server or another remote server may automatically control the transmission of the ads, sending the ads according to a selection mechanism. The selection of the ads may be carried out according to the user's current location, dialing history and personal details, for example; the user may receive all the ads that are considered by the system to be coordinated with the user's personal details such as his age, personal address, gender and the like.

According to embodiments of the present invention, the ads may be any type of message known in the art such as a multimedia message, text or voice messages. The ads may be transmitted through at least one of the messaging applications provided by user's network device 10 such as HTTP, SMS, USSD, MMS, WAV file downloaded and the like.

The ads may be transmitted directly to user's network device 10 without using device-application 20, according to some embodiments of the present invention (e.g. SMS, MMS). In these embodiments, the ad message may be sent by operation center 100 that may receive ad messages' content from other servers. Additionally or alternatively, ad messages may be sent directly by other servers provided that those servers receive the user's personal information from operation center 100.

According to some embodiments of the present invention, the destination or the domain name's owner may be automatically charged by the system for “events”, where the events are predefined by the system. For example, an event may be defined by the system whenever the communication sequence (e.g. phone number) related to the domain name is retrieved by a user's network device 10. For every retrieval of the domain name's related information the system may charge the domain name's owner according to a predefined payment agreement.

Additionally or alternatively, if device application 20 works through an internet communication and interface, en event may be defined by the system whenever the user has clicked a banner that queries the destination's related details such as, for example, the destination's phone number and/or URL address.

According to some embodiments of the present invention, the system may enable creating users' profiles by collecting user's information each time a domain name is requested by device application 20. For example, operation center 100 may receive and store information taken from device application 20 such as all domain names sent by each the user, times and frequencies of sending those domain names etc. This information can be stored by operation center 100 creating a profiles database containing useful information regarding the users dialing and shopping customs. This profiles database may facilitate in allowing domain owners or the system itself to advertise commodities or services, using this information and/or the analysis of this information.

The system may enable transmitting an advertising message (prerecorded, a video file and the like) while the connecting of a call is carried out. The system may enable automatic charging of domain names owners whenever an advertising message is sent. For example, operation center 100 may automatically send the calling user's network device 10 an advertisement file. Device application 20 may enable receiving messages that require processing such as video files and the like. The messages or the files may be preset per domain name and each domain name's owner may be charged per transmission of a message or a file.

According to some embodiments of the invention, operation center 100 may send predefined files or messages to device applications 20 of users during any stage of the calling process. For example, during the transmission of the domain name, during the call itself etc. The domain name's owner may set the operation center 100 to send the user, for example, a products' menu when after a call is initialed. The system may charge the owners per transmission of a message or a file.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system for retrieving at least one communication sequences of a destination and supporting the initiation of a call from a user to the destination, said system comprises:
a user's network device that comprises a device-application,
an operation center,
and a database;
wherein the device application enables sending an input domain name to the operation center, receiving a communication sequence that is associated with the said domain name and that is retrieved by the operation center from the database, and initiating a call to the destination through the user's network device using the said sequence.

2. The system of claim 1, wherein the device-application is a software application installed within the user's network device.

3. The system of claim 1, wherein communication between the user's network device and the destination's network device is carried out through at least one communication network.

4. The system of claim 1, wherein communication between the user's network device and the operation center is carried out through at least one communication network.

5. The system of claim 1, wherein the device-application enables presentation of the retrieved communication sequence in the user's network device.

6. The system of claim 5 further enables presentation of the destination's domain name and other domain name's related information.

7. The system of claim 1, wherein the device-application automatically initiates a call from the user's network device to a destination's network device, using the retrieved communication sequence.

8. The system of claim 1, wherein the operation center is a web-server that enables retrieval of communication sequences according lo input domain names from the database and transmission of said communication sequences lo the user's network device.

9. The system of claim 1 wherein said operation center further enables spelling checking and correcting of input domain names.

10. The system of claim 1 further comprises a at least one mediating operator, wherein the device application enables contacting a first mediating operator and transmitting said first operator the domain name's related information to enable said first operator to communicate with at least one second mediating operator that enables communication with the destination's network device, using said information.

11. The system of claim 10 wherein the transmission of said information is carried out by the user's network device and is enabled by the device application.

12. The system of claim 11, wherein said device application initiates a call to the first mediating operator and upon establishing said call allows the user's network device to transmit said information to the first mediating operator.

13. The system of claim 10, wherein the transmission of said information is carried out by the operation center.

14. The system of claim 13, wherein said transmission is carried out before the call has been established.

15. The system of claim 1 wherein said database further comprises post-dial data associated with at least some of the registered domain names, and said device application enables using said data to perform various calling and dialing functions.

16. The system of claim 11, wherein said post dial data are domain names' communication sequences' associated extension sequences.

17. The system of claim 12, wherein upon establishing the call, the device application enables retrieving and identifying said extension sequences and dialing said sequences after dialing the domain name's communication sequence.

18. The system of claim 10, wherein communication between the second and the third operators is carried out through VoIP.

19. The system of claim 1, wherein the database enables storing of several communication sequences attributed to a single domain name.

20. The system of claim 16 further enables storing a priority list associated with a single domain name, where the said list comprises time schedules corresponding to each of the domain name's communication sequences.

21. The system of claim 17, wherein the operation center automatically retrieves the domain name's communication sequences according to the said priority list.

22. The system of claim 1 wherein the device-application sends the domain names using at least one of the messaging services that are provided by the user's network device.

23. The system of claim 1 further enables automatic charging of a domain name's owner for events that are related to said owner, wherein said events and charging arrangements are predefined by the system.

24. The system of claim 23 wherein an event is defined when the operation center receives the owner's domain name from the user's network device.

25. The system of claim 1 further enables creating and storing users' profiles, wherein said profiles comprise user's related information and where said information is used for advertising purposes.

26. The system of claim 25 wherein said profiles include at least some of the sent domain names and time related information.

27. The system of claim 1 wherein once the user initiates a call to the destination, the operation center sends the user's network device at least one message, where said message is associated with the domain name and is predefined by the system.

28. The system of claim 27, wherein the message is a file and wherein the device application enables processing and displaying of said file.

29. A method for retrieving a communication sequence of a destination and supporting initiation of a call, wherein said retrieval is carried out using a user's device-application that is installed in a user's network device, an operation center and a database; said method comprises the steps of:
sending a domain name to the operation center, wherein the said domain name is sent by the device-application;
retrieving the domain name's communication sequences and associated information, wherein the operation center retrieves the sequences and the information from the database:
receiving the retrieved communication sequence, wherein the device application receives at least one of the said communication sequences;
executing a call to the destination's network device using at least one of the said sequences;
wherein the device-application initiates and executes the call to the destination's network device through the network using the calling mechanism of the user's network device.

30. The method of claim 29, wherein the device-application enables presentation of the retrieved communication sequence through the user's network device.

31. The method of claim 29, wherein communication between the user's network device and the destination's network device is carried out through at least one communication network.

32. The method of claim 29, wherein communication between the user's network device and the operation center is carried out through at least one communication network.

33. The method of claim 29, wherein executing a call to the destination's network device is carried out by the device application.

34. The method of claim 29 wherein the operation center retrieves at least one of several communication sequences associated with the domain name, where the said sequences are stored in the database.

35. The method of claim 34, wherein the said sequences are stored in the database according to a predefined priority list that comprises time schedules associated with the said communication sequences.

36. The method of claim 29 wherein the domain name is sent by the device-application using at least one of the messaging services that is enabled by the user's network device.

37. The method of claim 34 wherein the domain names are sent, through Unstructured Supplementary Service Data (USSD) messaging service.

38. The method of claim 29 further enables receiving of advertising messages, wherein the user's network device receives the said messages from the operation center.

39. The method of claim 29 wherein the device application retrieves the domain name's communication sequences and associated information from the operation center and where said application further enables transmitting said information to a first mediating operator, upon establishing a call with said first operator.

40. The method of claim 39 wherein the first mediating operator connects a second mediating operator and the second mediating operator enables connecting to the destination's network device.

41. The method of claim 40 wherein the charging of the user is automatically calculated by the operation center and includes the charge for connecting the mediating operator with the second mediating operator.

42. The method of claim 40 wherein the transmission of said information is carried out by the user's network device and is enabled by the device application.

43. The method of claim 42, wherein, said device application initiates a call to the first mediating operator and upon establishing said call transmits said information.

44. The method of claim 43, wherein the transmission of said information is carried out by the operation center.
